(19) United States
(12) Patent Application Publication
(10) Pub. No.: US 2026/0079301 A1
(43) Pub. Date: Mar. 19, 2026

(54) Monolithically Integrated Lithium Niobate On Silicon

(71) Applicant: Board of Regents, The University of Texas System, Austin, TX (US)

(72) Inventors: Alexander A. Demkov, Austin, TX (US); Agham Posadas, Round Rock, TX (US)

(73) Assignee: Board of Regents, The University of Texas System, Austin, TX (US)

(21) Appl. No.: 19/398,626

(22) Filed: Nov. 24, 2025

Related U.S. Application Data
(63) Continuation of application No. PCT/US2024/030556, filed on May 22, 2024.
(60) Provisional application No. 63/503,678, filed on May 22, 2023.

(51) Int. Cl. G02B 6/132; G02B 6/12

(52) U.S. Cl. CPC G02B 6/132; G02B 2006/1204; G02B 2006/12061; G02B 2006/12169

(57) ABSTRACT

A material according to the present technology may include a silicon substrate, a single crystal oxide buffer layer formed on the silicon substrate, and a layer of lithium niobate formed on the single crystal oxide buffer layer. A method of producing a material according to the present technology may include the steps of forming a single crystal oxide buffer layer on a silicon substrate and forming a layer of lithium niobate on the single crystal oxide buffer layer.

### CROSS REFERENCE TO RELATED PATENT APPLICATIONS

This patent application claims priority to and the benefit of International Patent Application No. PCT/US2024/030556, filed on May 22, 2024, entitled “MONOLITHICALLY INTEGRATED LITHIUM NIOBATE ON SILICON,” which in turn claims priority to and benefit of U.S. Provisional Patent Application No. 63/503,678 , filed on May 22, 2023, entitled the same, both of which are hereby incorporated by reference into this patent application.

### STATEMENT REGARDING FEDERALLY FUNDED RESEARCH

This invention was made with U.S. government support under Grant no. FA9550-18-1-0053 awarded by the Air Force Office of Scientific Research. The U.S. government has certain rights in the invention.

### BACKGROUND

Lithium niobate (LiNbO₃) is a material with applications in optical modulators and surface acoustic wave filters. Lithium niobate is used in many electro-optic applications and devices utilizing the piezoelectric effect, such as surface acoustic wave filters. In order to be more widely useful, large area wafers are needed. The size of currently grown LiNbO₃ on silicon (Si) is limited by the LiNbO₃ wafer size and requires complicated and expensive wafer bonding processes.

LiNbO₃ cannot be directly grown on silicon due to a thermodynamically unstable interface favoring the formation of silicides and silicates. Known technologies for combining lithium niobate with silicon tend to focus on wafer bonding slices of bulk wafers of LiNbO₃ grown by conventional crystal growth methods onto a separate silicon wafer. The current way of wafer bonding lithium niobate is energy intensive and complicated, and also limited to the small wafer sizes currently available for lithium niobate (6″). A such, opportunities exist in the field to increase the time and cost-efficiency (e.g., per area cost) of known processes for growing LiNbO₃ on silicon substrates.

Accordingly, a need exists for technology that overcomes the problems demonstrated above, as well as one that provides additional benefits. The examples provided herein of some prior or related devices, systems and methods, and their associated limitations, are intended to be illustrative and not exclusive. Other limitations of existing or prior systems will become apparent to those of skill in the art upon reading the following detailed description.

### SUMMARY

A first aspect of the disclosure provides a material. The material according to the first aspect may include a silicon substrate. The material of the first aspect may include a single crystal oxide buffer layer formed on the silicon substrate. The material of the first aspect may include a layer of lithium niobate formed on the single crystal oxide buffer layer. A second aspect of the disclosure provides a wafer. The wafer may include the material according to one or more of the embodiments according to the first aspect of the disclosure. A third aspect the disclosure provides a waveguide or a device including such a waveguide. The waveguide or waveguide device according to the third aspect of the disclosure may include the material according to one or more of the embodiments according to the first aspect of the disclosure.

A fourth aspect of the disclosure provides a method of producing the material according to the first aspect. The method according to the fourth aspect may include the step of forming a single crystal oxide buffer layer on a silicon substrate. The method according to the fourth aspect may include forming a layer of lithium niobate on the single crystal oxide buffer layer. A fifth aspect of the disclosure provides a method of producing a waveguide or a device including such a waveguide. The method according to the fifth aspect may include one or more of the method steps according to the fourth aspect of the disclosure.

A sixth aspect of the disclosure provides a material. The material according to the sixth aspect may include a silica layer or a silica substrate (may be referred to herein more succinctly as “silica”). The material of the sixth may include a single crystal oxide buffer layer formed on the silica. The material of the sixth aspect may include a layer of lithium niobate formed on the single crystal oxide buffer layer. A seventh aspect of the disclosure provides a wafer. The wafer may include the material according to one or more of the embodiments according to the sixth of the disclosure. An eighth aspect of the disclosure provides a waveguide or a device including such a waveguide. The waveguide or waveguide device according to the eighth aspect of the disclosure may include the material according to one or more of the embodiments according to the sixth aspect of the disclosure. A ninth aspect of the disclosure provides a method of producing the material according to the sixth aspect. A tenth aspect of the disclosure provides a method of producing a waveguide or a device including such a waveguide. The method according to the tenth aspect may include one or more of the method steps according to the ninth aspect of the disclosure.

### BRIEF DESCRIPTION OF THE DRAWINGS

Embodiments of the present technology will be described and explained through the use of the accompanying drawings.

FIG. 1A depicts a cross-sectional view of a piece of a material, according to some embodiments of the present technology.

FIG. 1B depicts a cross-sectional view of a piece of a material, according to other embodiments of the present technology.

FIG. 1C depicts a perspective view of a wafer formed of, or including, the material shown in FIG. 1A or 1B, according to some embodiments of the present technology.

FIG. 2 depicts a flowchart of a method for manufacturing a material, according to some embodiments of the present technology.

FIG. 3 provides a plot showing X-ray photoemission (XPS) measurement of an LiNbO₃ film according to the present technology to determine Li to Nb ratio.

FIGS. 4A and 4B provide results of reflection high energy electron diffraction (RHEED) of a monolithically integrated LiNbO₃ layer on Si.

FIG. 5 provides a plot showing results of out of plane X-ray diffraction of the LiNbO₃ layer of a material according to some embodiments of the present technology.

FIG. 6 provides a plot showing results of in plane X-ray diffraction of the LiNbO₃ layer of a material according to some embodiments of the present technology.

FIG. 7 provides a plot of the real (n) and imaginary (k) parts of the refractive indices of the LiNbO₃ layer according to the present technology as extracted from spectroscopic ellipsometry for the entire monolithically integrated stack.

FIG. 8 depicts a cross-sectional view of a waveguide device including the material shown in FIG. 1A or FIG. 1B, according to some embodiments of the present technology.

FIG. 9 depicts a flowchart of a method for manufacturing a material, according to some embodiments of the present technology.

FIG. 10 depicts a heat map style cross-sectional view of a waveguide device of FIG. 8 under a simulated energization test.

FIG. 11 depicts a plot of effective index of fundamental mode versus thickness of the single crystal oxide buffer layer from the simulation example of FIG. 10.

The drawings have not necessarily been drawn to scale. Similarly, some components and/or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

LiNbO₃ cannot be directly grown on silicon due to a thermodynamically unstable interface favoring the formation of silicides and silicates; hence the epitaxial oxide buffer layer as used according to the present technology may enable direct integration of LiNbO₃ on Si. Layer stacks according to the present technology would allow the growth of large scale LiNbO₃ bulk-like films on the large area Si wafer platform. The ability to have homogenous LiNbO₃ over large area silicon wafers makes the present technology a crucial missing link for making high density photonic integrated circuits.

The present technology enables the integration and processing of LiNbO₃ directly into the silicon processing line and allows for growth on large scale wafer substrates. Layer stacks according to the present technology would allow the growth of large scale LiNbO₃ bulk-like films on the Si wafer platform, which are required for high density photonic integrated circuits and on-die surface acoustic wave filters. The present technology opens the door for a multitude of new use cases that have not yet been implemented due to the lack of large area wafers. LiNbO₃ can also a used for fabricating surface acoustic wave filters for 6G technology. The epitaxial integration onto silicon should allow for the construction of a wide range of novel devices relying on the electro-optic and piezoelectric properties of LiNbO₃. The present technology may find suitable applications in technological fields including, without limitation, the silicon photonics industry, surface acoustic wave filter industry, and research materials suppliers.

Disclosed herein is a route to integrate crystalline lithium niobate grown epitaxially on silicon (001) and silicon (111) substrates via an epitaxial crystalline oxide buffer layer. Specifically, a material and method of making it provides, for example and without limitation, the following layer stack: silicon (001) substrate/thin film γ-Al₂O₃ (buffer layer)/thin film LiNbO₃, and alternatively, silicon (111) substrate/thin film bixbyite R₂O₃ (buffer layer)/thin film LiNbO₃. Such a materials system could be used as template layer for thick bulk-like metal organic chemical vapor deposition (MOCVD)-grown LiNbO₃ films directly integrated on silicon. Lithium niobate is used in many electro-optic applications and devices utilizing the piezoelectric effect, such as surface acoustic wave filters.

The layer stack according to the present technology has not previously been prepared to the best of our knowledge. Known technologies for combining lithium niobate with silicon tend to focus on wafer bonding slices of bulk wafers of LiNbO₃ grown by conventional crystal growth methods onto a separate silicon wafer. The hetero-epitaxial integration of LiNbO₃ onto silicon enables a cheaper way of incorporating lithium niobate technology in state-of-the-art semiconductor fabs specialized in the processing of silicon devices on large scale, 300 mm wafer diameters allowing for cost-effective production.

The present technology has the advantage of integrating the robust electro-optic material LiNbO₃ directly on the Si semiconductor platform for which many device fabrication technologies are widely available. The current way of wafer bonding lithium niobate is energy intensive and complicated, and also limited to the small wafer sizes currently available for lithium niobate (6″). We offer a path to 300 mm LiNbO₃ directly on Si or Si-on-Insulator (SOI) wafers.

LiNbO₃ films initially grown according to the present technology can act as a seed layer for further deposited LiNbO₃ by MOCVD or a similar method; it is expected that the crystalline quality will drastically improve with increasing film thickness. Furthermore, post-processing methods like annealing can improve crystalline quality and polishing or etching can smoothen out a rough surface of such grown films to obtain high-quality Si/epi-oxide/LiNbO₃ stacks. Another method to improve the lattice matching between the silicon/epi-oxide platform and LiNbO₃ is to use a bixbyite alloy R1ₓR2₁₋ₓO₃ as the buffer layer to tune the in-plane lattice spacing of the buffer.

The practice of the present technology opens the door for a multitude of new use cases that have not yet been considered. LiNbO₃ is one of the materials of choice for high efficiency electro-optic modulators. The epitaxial integration of LiNbO₃ onto the silicon layer should allow for the construction of a wide range of photonic integrated circuits relying on the manipulation of optical signals on a silicon photonics platform. The present technology could also enable on-die surface acoustic wave (SAW) filters for 6G technology and the Internet of Things (IoT) field.

Based on the description provided herein, the present technology may also be considered as a process of producing a material that includes epitaxial growth of LiNbO₃ on Si (001) and Si (111) using a spinel or bixbyite buffer, or a producing a material that includes epitaxial growth of LiNbO₃ on Si (111) via an epitaxial oxide buffer.

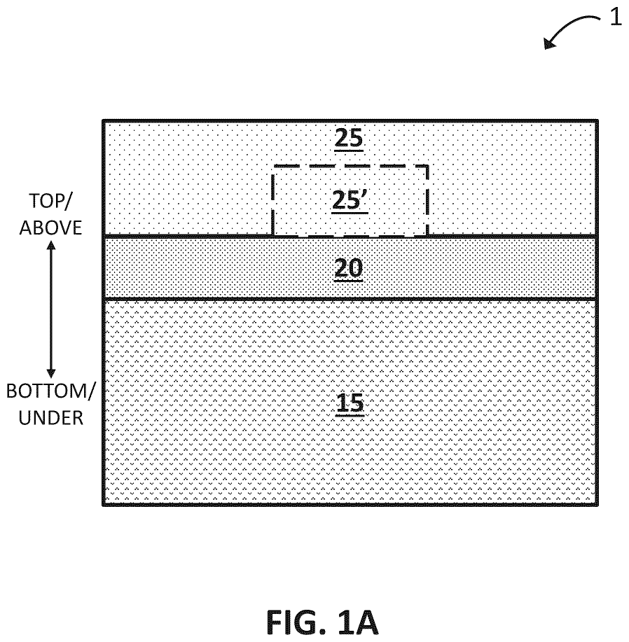

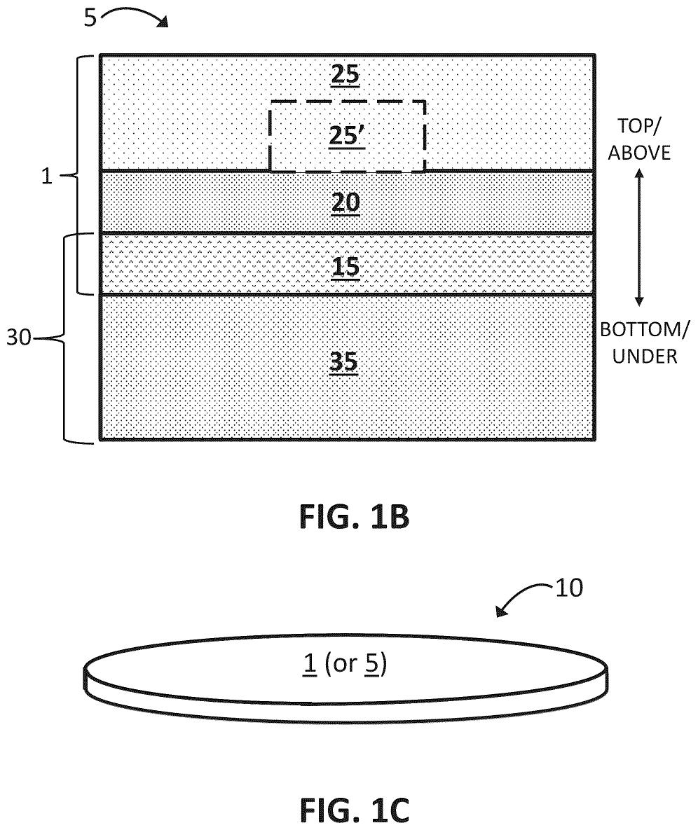

FIG. 1A depicts a cross-sectional view of a piece of a material 1, according to some embodiments of the present technology. FIG. 1B depicts a cross-sectional view of a piece of a material 5, according to other embodiments of the present technology. FIG. 1C depicts a perspective view of a wafer 10 formed of, or including, the material (1 or 5) shown in FIG. 1A or 1B, according to some embodiments of the present technology. Referring to FIG. 1A, the material 1 according to the present technology may include a silicon substrate 15 and a single crystal oxide buffer layer 20 formed, or otherwise deposited, on at least a portion of silicon substrate 15. Material 1 may include a layer of lithium niobate 25 formed, or otherwise deposited, on at least a portion of the single crystal oxide buffer layer 20. The layer of lithium niobate 25 may be monolithically integrated in material 1. In an example, silicon substrate 15 may be, or may include, Si (001). In another example, silicon substrate 15 may be, or may include, Si (111).

Referring now to FIG. 1B, the material 5 according to the present technology may include the above-described features of material 1. That is, material 5 may include silicon substrate 15, single crystal oxide buffer layer 20 formed on silicon substrate 15, and the layer of lithium niobate 25 formed on single crystal oxide buffer layer 20. As in material 1, the layer of lithium niobate 25 may be monolithically integrated in material 5. In some embodiments, the difference between material 1 and material 5 is that silicon substrate 15 of material 5 is, or includes, a device silicon layer (e.g., Si (001) or Si (111)) of a silicon on insulator (SOI) material 30 (e.g., SOI wafer), where the balance of SOI material under silicon substrate 15 may be, for example and without limitation, silica, or silica-containing, material 35. In an example, a specialized SOI-based silicon substrate 15 may be utilized in producing material 5, where the device Si layer is 111-oriented while a carrier wafer underlaying the material 35 layer may be 100-oriented.

Referring now to FIG. 1C, the silicon substrate 15 of the material 1 or material 5 according to the present technology may be provided, at least in part, in the form of a silicon, or silicon containing, wafer and the resulting material 1 or 5 produced according to the present technology may be in the form of wafer 10. In some embodiments, wafer 10 may be, or may at least contain, the material 1 or the material 5 according to the present technology.

As used herein, the term “about” means equal to, or approximately equal to, the stated value, such as within a tolerance (±) range of the stated value that allows for variation in precision and/or accuracy as between two or more instruments of the same, or different, type, operators, instruments, or techniques, taking the measurement resulting in the value of the particular parameter (e.g., for comparison to the stated value). Depending on such factors as, for example and without limitation, the size or magnitude of the value, conditions under which the measurement is taken, conversions from standard units to metric or SI units, the nature of the measured physical or chemical property corresponding to the stated value, the availability of art-recognized standard measurements (e.g., as maintained by NIST or another formal or informal standards setting body), among other factors, about may take on a more narrow definition. As applied to a value or range of values for wafer diameter and layer widths as described and/or claimed herein, “about” means that the value or range of values may vary by ±0.3 inches from the stated value(s). In some embodiments, wafer 10 may have a diameter of from about 1 inch to about 18 inches. In an example, wafer 10 may have a diameter of from about 2 inches to about 12 inches. In another example, wafer 10 may have a diameter of from about 4 inches to about 8 inches.

In some embodiments, single crystal oxide buffer layer 20 of material 1 or material 5 may be, or may include, a spinel buffer. In other embodiments, single crystal oxide buffer layer 20 of material 1 or material 5 may be, or may include, a bixbyite buffer. In an example, the bixbyite buffer may have, or may include, a composition defined as R1ₓR2₁₋ₓO₃, where R1 or R2 can be any Group 3 element that normally forms in a bixbyite crystal structure. In still other embodiments, the single crystal oxide buffer layer 20 may be, or may include, a wurtzite buffer. In an example, the wurtzite buffer may be, or may include, zinc oxide (ZnO). As a first prophetic example of material 1 or material 5, the single crystal oxide buffer layer 20 formed as wurtzite buffer may be, or may include, magnesium oxide (MgO), either instead of, or in addition to, ZnO. As a second prophetic example of material 1 or material 5, the single crystal oxide buffer layer 20 formed as wurtzite buffer may be, or may include, ZnO doped with MgO to provide the wurtzite crystalline structure for layer 20. As a third prophetic example of material 1 or material 5, the single crystal oxide buffer layer 20 formed as wurtzite buffer may be, or may include, silicon carbide (SiC) and/or gallium nitride (GaN), either instead of, or in addition to, ZnO and/or MgO. Use of SiC and/or GaN for the single crystal oxide buffer layer 20 formed as wurtzite buffer may be challenging due to presence of oxygen (e.g., during production), but may be a subject of further consideration and development for particular technological applications of material 1 or material 5.

In material 1 or material 5, the single crystal oxide buffer layer 20 may be, or may include, an epitaxial oxide. In some embodiments, single crystal oxide buffer layer 20 may be, or may include, aluminum oxide (Al₂O₃). In an example, single crystal oxide buffer layer 20 may be, or may include γ-Al₂O₃. In other embodiments, single crystal oxide buffer layer 20 may be, or may include, a rare earth oxide. In an example, single crystal oxide buffer layer 20 may be, or may include, one, or a combination of two or more, of gadolinium oxide (Gd₂O₃), neodymium oxide (Nd₂O₃), yttrium oxide (Y₂O₃), praseodymium oxide (Pr₂O₃), cerium oxide (Ce₂O₃), and erbium oxide (Er₂O₃), and indium oxide (In₂O₃). In some cases, depending on the specifications and/or requirements of a particular application of the present technology, these rare earth oxide materials can be mixed for purposes of tuning and obtaining a precise lattice constant value for the single crystal oxide buffer layer 20.

As applied to a value or range of values for layer thickness as described and/or claimed herein, “about” means that the value or range of values in nanometers (nm) may vary by ±10% from the stated value(s). In some embodiments, single crystal oxide buffer layer 20 may have a thickness of from 1 nanometer (nm) to 10 nm. In an example, single crystal oxide buffer layer 20 may have a thickness of from 1 nm to 5 nm. In another example, single crystal oxide buffer layer 20 may have a thickness of from 5 nm to 10 nm. In other embodiments, single crystal oxide buffer layer 20 may have a thickness of from 10 nm to 100 nm. In an example, single crystal oxide buffer layer 20 may have a thickness of from 10 nm to 50 nm. In another example, single crystal oxide buffer layer 20 may have a thickness of from 50 nm to 100 nm. In yet another example, single crystal oxide buffer layer 20 may have a thickness of from 80 nm to 100 nm. For some applications for waveguide devices, as further discussed below, a single crystal oxide buffer layer 20 thickness of greater than about 80 nm may be desirable. In yet other embodiments, single crystal oxide buffer layer 20 may have a thickness of from 100 nm to 1 micron (μm). In an example, single crystal oxide buffer layer 20 may have a thickness of from 100 nm to 500 nm. In another example, single crystal oxide buffer layer 20 may have a thickness of from 500 nm to 1 μm. In still other embodiments, single crystal oxide buffer layer 20 may have a thickness of from 1 μm to 10 μm. In an example, single crystal oxide buffer layer 20 may have a thickness of from 1 μm to 5 μm. In another example, single crystal oxide buffer layer 20 may have a thickness of from 5 μm to 10 μm. Notably, there is no theoretical maximum thickness of the single crystal oxide buffer layer 20. Various applications of the present technology may call for varying thicknesses or ranges thereof for single crystal oxide buffer layer 20.

In some embodiments, the layer of lithium niobate 25 may be epitaxially grown on the silicon substrate 15 via the single crystal oxide buffer layer 20. In an example, the layer of lithium niobate 25 may have a thickness of greater than or equal to 8 unit cells. In another example, the layer of lithium niobate 25 may have a thickness of greater than or equal to about 10 nm. In one embodiment, layer of lithium niobate 25 may have ferroelectric properties, or it may have piezoelectric properties, either instead of, or in addition to, being ferroelectric. The presence, or the extent, of such ferroelectric and/or piezoelectric properties of layer of lithium niobate 25 may depend, at least in part, on the thickness of layer 25. In an example, layer 25 may be about 120 nm thick. Notably, there is no theoretical maximum thickness of the layer of lithium niobate 25. Various applications of the present technology may call for varying thicknesses or ranges thereof for layer of lithium niobate 25. Up to 300 millimeters (mm) of LiNbO₃ is expected to be readily and economically feasible in practice of the present technology.

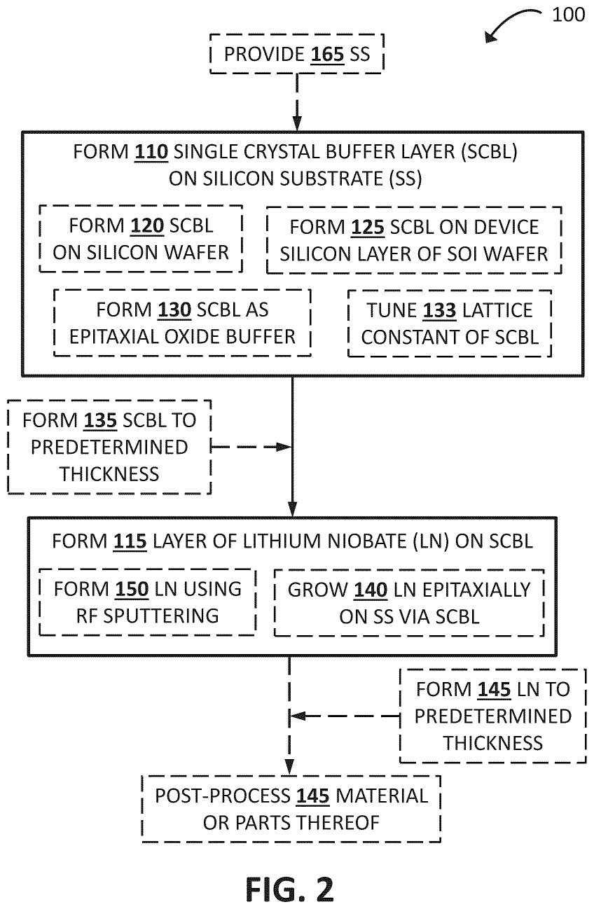

FIG. 2 depicts a flowchart of a method 100 for producing a material (e.g., material 1 or material 5), according to some embodiments of the present technology. Method 100 may include the step of forming 110, or otherwise depositing, the single crystal oxide buffer layer 20 on the silicon substrate 15. Method 100 may include the step of forming 115 the layer of lithium niobate 25 on the single crystal oxide buffer layer 20. In an example, a starting material for silicon substrate 15 for the forming 110 step in method 100 may be, or may include, Si (001). In another example, the starting material for silicon substrate 15 for the forming 110 in method 100 may be, or may include, Si (111).

In some embodiments, the method 100 step of forming 110 the single crystal oxide buffer layer 20 on silicon substrate 15 may include forming 120 the single crystal oxide buffer layer 20 on a silicon wafer. In other embodiments, forming 110 the single crystal oxide buffer layer 20 on silicon substrate 15 may include forming 125 the single crystal oxide buffer layer 20 on the device silicon layer of SOI wafer 30 (e.g., for producing material 5 using method 100). In still other embodiments, forming 110 the single crystal oxide buffer layer 20 on silicon substrate 15 may include forming a spinel buffer on the silicon substrate. In an example, a specialized SOI-based silicon substrate 15 may be utilized in producing material 5, where the device Si layer may be, or may include, 111-oriented Si while a bottommost carrier wafer of SOI wafer 30 may be 100-oriented Si.

In one embodiment, the method 100 step of forming 110 the single crystal oxide buffer layer 20 may include forming a bixbyite buffer on silicon substrate 15. In an example, forming the bixbyite buffer in method 100 may include forming the bixbyite buffer having a composition defined as R1ₓR2₁₋ₓO₃, where R1 or R2 can be any Group 3 element that normally forms in a bixbyite crystal structure. In another embodiment, the method 100 step of forming 110 the single crystal oxide buffer layer 20 may include forming a wurtzite buffer on silicon substrate 15. In an example, forming the wurtzite buffer on silicon substrate 15 may include forming the wurtzite buffer of, or including, ZnO on silicon substrate 15. In a prophetic example, forming the wurtzite buffer on silicon substrate 15 may include forming the wurtzite buffer of, or including, MgO—either instead of, or in addition to, ZnO—on silicon substate 15. In another prophetic example, forming the wurtzite buffer on silicon substrate 15 may include forming the wurtzite buffer of, or including, ZnO doped with MgO on Si substrate 15. In yet another prophetic example, forming the wurtzite buffer on silicon substrate 15 may include forming the wurtzite buffer of, or including SiC and/or GaN, either instead of, or in addition to, forming the wurtzite buffer of ZnO and/or MgO.

In some embodiments, the forming 110 step in method 100 may include forming 130 an epitaxial oxide buffer on silicon substrate 15. In an example, forming 110 single crystal oxide buffer layer 20 on silicon substrate 15 may include forming the single crystal oxide buffer layer 20 including Al₂O₃ on silicon substrate 15, where Al₂O₃ may be, or may include, γ-Al₂O₃. In another example, forming 110 single crystal oxide buffer layer 20 on silicon substrate 15 may include forming single crystal oxide buffer layer 20 including a rare earth oxide on silicon substrate 15, where the rare earth oxide may be, or may include, one, or a combination of two or more, of Gd₂O₃, Nd₂O₃, Y₂O₃, Pr₂O₃, Ce₂O₃, Er₂O₃, and In₂O₃. In some cases, depending on the specifications and/or requirements of a particular application of the present technology, a plurality of such rare earth oxide materials can be mixed for purposes of tuning 133 and obtaining a precise lattice constant value for the single crystal oxide buffer layer 20 in method 100.

In method 100, forming 110 single crystal oxide buffer layer 20 on silicon substrate 15 may include forming 135 layer 20 to a predetermined (e.g., desired) thickness. In one embodiment, the forming 110 step of method 100 may include forming single crystal oxide buffer layer 20 having a thickness of from about 1 nm to about 10 nm on silicon substrate 15. In an example, single crystal oxide buffer layer 20 may be formed 110 on silicon substrate 15 in method 100 to a thickness of from about 1 nanometer (nm) to about 10 nm. In another example, single crystal oxide buffer layer 20 may be formed 110 on silicon substrate 15 in method 100 to a thickness of from about 1 nm to about 5 nm. In yet another example, single crystal oxide buffer layer 20 may be formed 110 on silicon substrate 15 in method 100 to a thickness of from about 5 nm to about 10 nm.

In some embodiments, the forming 110 step of method 100 may include forming single crystal oxide buffer layer 20 having a thickness of from about 10 nm to about 100 nm on silicon substrate 15. In an example, single crystal oxide buffer layer 20 may be formed 110 on silicon substrate 15 in method 100 to a thickness of from about 10 nm to about 50 nm. In another example, single crystal oxide buffer layer 20 may be formed 110 on silicon substrate 15 in method 100 to a thickness of from about 50 nm to about 100 nm. In yet another example, single crystal oxide buffer layer 20 may be formed 110 on silicon substrate 15 in method 100 to a thickness of from about 80 nm to about 100 nm. In other embodiments, the forming 110 step of method 100 may include forming single crystal oxide buffer layer 20 having a thickness of from about 100 nm to about 1 micron (μm) on silicon substrate 15. In an example, single crystal oxide buffer layer 20 may be formed 110 on silicon substrate 15 in method 100 to a thickness of from about 100 nm to about 500 nm. In another example, single crystal oxide buffer layer 20 may be formed 110 on silicon substrate 15 in method 100 to a thickness of from about 500 nm to about 1 μm.

In other embodiments, the forming 110 step of method 100 may include forming single crystal oxide buffer layer 20 having a thickness of from about 1 μm to about 10 μm on silicon substrate 15. In an example, single crystal oxide buffer layer 20 may be formed 110 on silicon substrate 15 in method 100 to a thickness of from about 1 μm to about 5 μm. In another example, single crystal oxide buffer layer 20 may be formed 110 on silicon substrate 15 in method 100 to a thickness of from about 5 μm to about 10 μm.

In some embodiments, forming 110 or otherwise depositing single crystal oxide buffer layer 20 on silicon substrate 15 may be performed using, at least in part, molecular beam epitaxy (MBE) under process conditions sufficient to achieve a predetermined thickness for the single crystal oxide buffer layer 20. In some embodiments, MBE for forming 110 a non-volatile oxide (e.g., Er₂O₃) may be performed under process conditions sufficient to achieve a predetermined thickness for the single crystal oxide buffer layer 20 composed of the non-volatile oxide. The MBE process conditions may include a temperature of from about 600° C. to about 800° C. In an example, the MBE chamber temperature may be about 700° C. The MBE process conditions may include an oxygen (O₂) pressure of about 1×10⁻⁶ Torr. In an example, the MBE chamber temperature may be about 700° C. As compared to forming 110 the buffer layer 20 of a non-volatile oxide, forming 110 a buffer layer 20 composed of a volatile oxide (e.g., ZnO) would be expected to require a comparably lower chamber temperature to prevent, or at least mitigate, vaporization of the material being deposited on Si substrate 15.

In a prophetic example, forming 110 or otherwise depositing single crystal oxide buffer layer 20 on silicon substrate 15 may be performed using, at least in part, radio frequency (RF) sputtering under process conditions sufficient to achieve a predetermined thickness for the single crystal oxide buffer layer 20. In another prophetic example, forming 110 or otherwise depositing single crystal oxide buffer layer 20 on silicon substrate 15 may be performed using, at least in part, pulsed laser deposition (PLD) under process conditions sufficient to achieve a predetermined thickness for the single crystal oxide buffer layer 20. In yet another prophetic example, forming 110 or otherwise depositing single crystal oxide buffer layer 20 on silicon substrate 15 may be performed using, at least in part, chemical vapor deposition (CVD) under process conditions sufficient to achieve a predetermined thickness for the single crystal oxide buffer layer 20.

In some embodiments, forming 115 the layer of lithium niobate 25 on single crystal oxide buffer layer 20 in method 100 may include epitaxially growing 140 the layer of lithium niobate 25 on silicon substrate 15 via the single crystal oxide buffer layer 20. In method 100, forming 115 the layer of lithium niobate 25 on single crystal oxide buffer layer 20 may include forming 145 layer 25 to a predetermined (e.g., desired) thickness. In one embodiment, the forming 115 step of method 100 may include forming the layer of lithium niobate 25 having a thickness of greater than or equal to 8 unit cells on single crystal oxide buffer layer 20. In an example, the forming 115 step may include forming the layer of lithium niobate 25 having a thickness of greater than or equal to 1000 Angstrom.

In some embodiments, the forming 115 step of method 100 may include forming the layer of lithium niobate 25 having a thickness of greater than or equal to about 10 nm on the single crystal oxide buffer layer 20. In an example, the layer of lithium niobate 25 may be formed 115 on single crystal oxide buffer layer 20 in method 100 to a thickness of about 120 nm. In one embodiment, layer 25 may be formed to a sufficient thickness such that the layer of lithium niobate 25 exhibits ferroelectric properties. In other embodiments, layer 25 may be formed or otherwise deposited to a thickness sufficient such that the layer of lithium niobate 25 exhibits piezoelectric properties, either instead of, or in addition to, layer 25 exhibiting ferroelectric properties.

In one embodiment, forming 115 the layer of lithium niobate 25 in method 100 may be performed 150, at least in part, using RF sputtering under process conditions sufficient to achieve a predetermined thickness for the layer of lithium niobate 25. In an example, performing 150 RF sputtering to form 115 layer 25 in method may include RF sputtering the layer of lithium niobate onto the single crystal oxide buffer layer 20 from an Li-rich sputtering target. In another example, performing 150 RF sputtering to form 115 layer 25 in method may include RF sputtering the layer of lithium niobate onto the single crystal oxide buffer layer 20 from a stoichiometric sputtering target.

In practice of method 100 according to the present technology with performance 150 of RF sputtering, a ratio of lithium to niobium of about 1:1 for layer 25 composition may be obtained. In the context of such a ratio, the term “about” means that the layer of lithium niobate 25 may be composed of from 48% to 52% Li and the remainder Nb. Even with use of the stoichiometric, or Li-rich, target, layer 25 may be Li deficient after the forming 115 step of method 100, including with any post-processing 170 step(s) of method 100. However, greater than 49% Li content for layer 25 is attainable, and any such comparable levels of Li deficiency (e.g., down to about 48% Li) are expected to impact performance of a final product application (e.g., optical or other waveguides) only negligibly, if at all.

Process conditions for performing 150 RF sputtering in method 100 may include a sputtering temperature. In one embodiment, the temperature for RF sputtering may be from about 500° C. to about 600° C. In an example, the temperature for RF sputtering in the performing 150 step of method 100 may be about 500° C. As applied to a value or range of values for sputtering temperature as described and/or claimed herein, “about” means that the value or range of values in ° C. may vary by ±5° C. from the stated value(s).

Process conditions for performing 150 RF sputtering in method 100 may include a sputtering pressure. In some embodiments, the sputtering pressure may be from about 150 mTorr to about 200 mTorr. In an example, the RF sputtering pressure in the performing 150 step of method 100 may be about 175 mTorr. As applied to a value or range of values for pressure as described and/or claimed herein, “about” means that the value or range of values in mTorr may vary by ±5 mTorr from the stated value(s).

Process conditions for performing 150 RF sputtering in method 100 may include a growth rate for the layer of lithium niobate 25. In one embodiment, the growth rate may be from about 1.0 nm/min to about 1.6 nm/min. As applied to a value or range of values for a growth rate in nm/min as described and/or claimed herein, “about” means that the value or range of values of such ratio may vary by ±10% from the stated value(s).

Process conditions for performing 150 RF sputtering in method 100 may include a gas mixture. In some embodiments, the gas mixture for performing 150 RF sputtering in method 100 may be 40% O₂ and 60% argon. Process conditions for performing 150 RF sputtering in method 100 may include a plasma power density. In some embodiments, the plasma power density may be 5 W/cm².

In a prophetic example, forming 115 the layer of lithium niobate 25 in method 100 may be performed, at least in part, using one or more other techniques instead of, or in addition to, RF sputtering, where such other technique(s) may be performed under process conditions sufficient to achieve a predetermined thickness for the layer of lithium niobate 25. In an example, the aforementioned other techniques may include at least one of: MBE (e.g., using niobium chloride), CVD, and hydride vapor deposition (HVD).

In one embodiment, the layer of lithium niobate 25 may be formed 115 in method 100 in at least two stages of deposition. In such cases, a seed layer of LiNbO₃ may be initially deposited 155 on single crystal oxide buffer layer 20, and then a remainder of the layer of lithium niobate 25 may be further deposited 160 on the seed layer to thereby achieve the predetermined thickness overall for layer 25. In an example, the aforementioned seed layer may be initially deposited 155 using RF sputtering and the remainder of layer 25 may be further deposited 160 on seed layer using metal-organic chemical vapor deposition (MOCVD).

In some embodiments, method 100 may include the step of providing 165 silicon substrate 15 prior to forming 110 single crystal oxide buffer layer 20 thereon. In one embodiment, providing 165 silicon substrate 15 in method 100 may include providing the silicon substrate 15 as a piece of Si (e.g., wafer) having at least its topmost surface being, or including, Si (001) or Si (111). In some embodiments, the providing 165 step may include providing the silicon substrate 15 as an Si wafer having a diameter of from about 1 inch to about 18 inches. In an example, the Si wafer may be provided as an Si wafer having a diameter of from about 2 inches to about 12 inches. In another example, the Si wafer may be provided as an Si wafer having a diameter of from about 4 inches to about 8 inches.

### Characterization of the Monolithically Integrated LiNbO₃ Layer According to the Present Technology

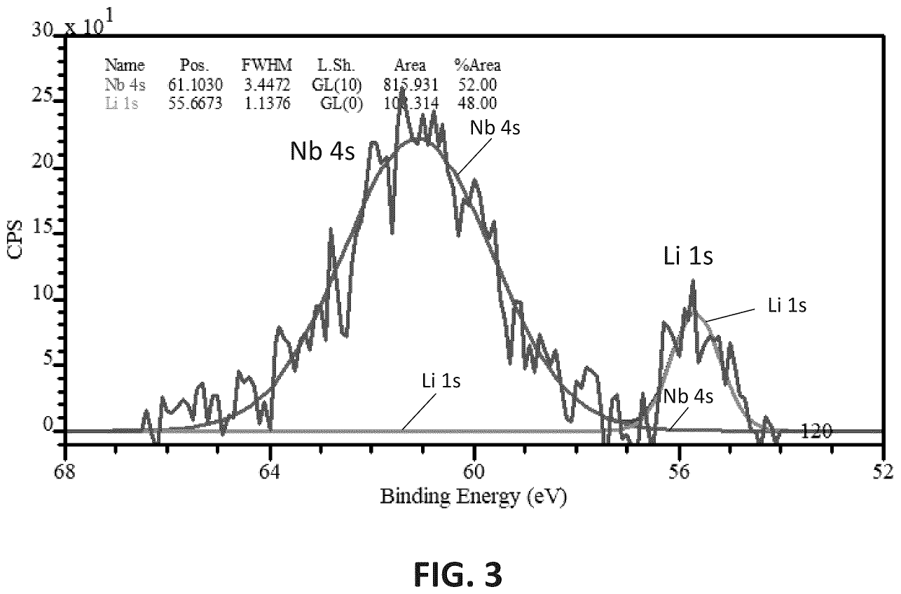

FIG. 3 provides a plot showing X-ray photoemission (XPS) measurement of an LiNbO₃ film according to a material to the present technology to determine Li to Nb ratio. The x-axis is binding energy (eV), and the y-axis is counts per second (CPS). The scan is of the Nb 4s and Li 1s region using relative sensitivity factors calibrated for single crystal LiNbO₃. This shows minimal Li loss and film is stoichiometric to within the error of the measurement. This particular region of binding energy has both niobium and lithium core level peaks, 4s and 1s, respectively. These are used to determine the relative compositions of niobium and lithium in the layer 25 of LiNbO₃. In the case shown in FIG. 3, layer 25 of the material of the present technology produced using method 100 had a composition of 48% lithium and 52% niobium.

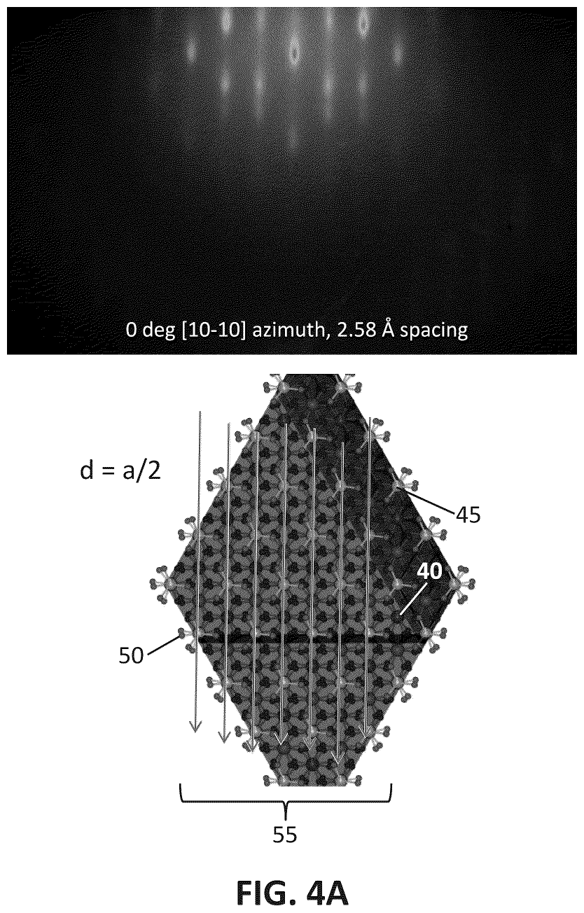

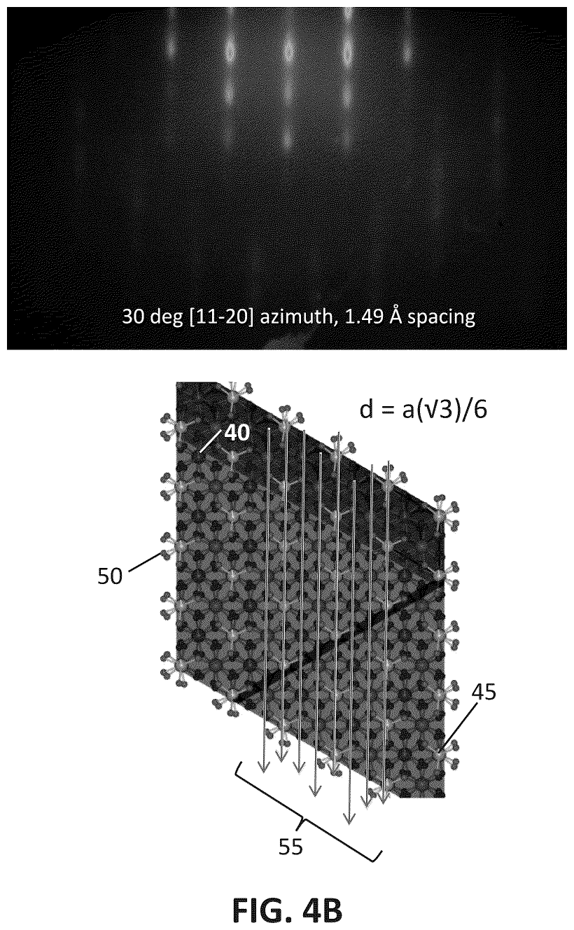

FIGS. 4A and 4B provide results of reflection high energy electron diffraction (RHEED) of a monolithically integrated LiNbO₃ layer 25 on silicon substrate 25. As shown in the top panel of FIG. 4A, the RHEED results show streaks with 6-fold symmetry and spacings corresponding to the expected atomic spacings at the high symmetry directions. FIG. 4A, top panel, is taken along the [10-10] zone axis showing a lattice spacing (d) of a_{LiNbO3}/2=2.58 Å (“a” denotes the a-lattice constant). FIG. 4B (rotated 30 degrees as compared to FIG. 4A, which provides the 0 degrees azimuth) is taken along the [11-20] zone axis showing a lattice spacing (“d”) of a_{LiNbO3}*√3/6=1.49 Å. The corresponding lattice spacings are shown as parallel arrow lines 55 on an atomic model of the c-plane of LiNbO₃. This shows a single domain c-oriented LiNbO₃ surface.

The bottom panels of FIGS. 4A and 4B illustrate the atomic model of the layer of lithium niobate 25 under test. Atoms labeled 40 are niobium, atoms labeled 45 are lithium, and atoms labeled 50 are oxygen. The spacings being referred to are the distances between the arrows 55. Note that RHEED spacing is inversely proportional. The arrows 55 shown in the bottom panels of FIGS. 4A and 4B are the direction of the electron beam relative to the crystal orientation. The spacing between the arrows 55 indicates the lateral period—the periodicity in the indicated direction. Only the lateral periodicity is determinable, so each arrow 55 goes through a particular atomic column. The columns are all identical and have the same structure and the same arrangement—that is the reason they are periodic. The results of FIGS. 4A and 4B confirm that the 001 plane of LiNbO₃ is present on the top surface of the layer of lithium niobate 25 in the material produced according to the present technology.

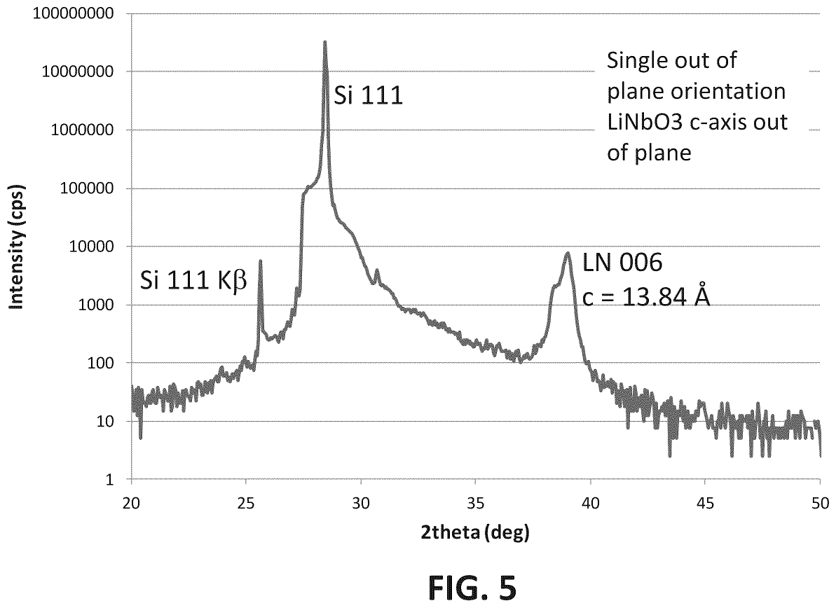

FIG. 5 provides a plot showing results of X-ray diffraction of the material of the present technology in the out of plane direction. The results shown in FIG. 5 demonstrate a single out of plane orientation LiNbO₃ c-axis out of plane. No other orientation of LiNbO₃ was observed in this experiment. The obtained value of c_{LiNbO3} is 13.84 Å. From the plot of FIG. 5, one can also see an initial strained layer (shoulder to the left of the LiNbO₃ peak denoted “LN 006” that relaxes as the LiNbO₃ layer is made thicker. This observed shoulder is believed to arise from a strained layer, where the LiNbO₃ initially grows strained in the forming 115 step of method 100, but then snaps into its normal lattice constant.

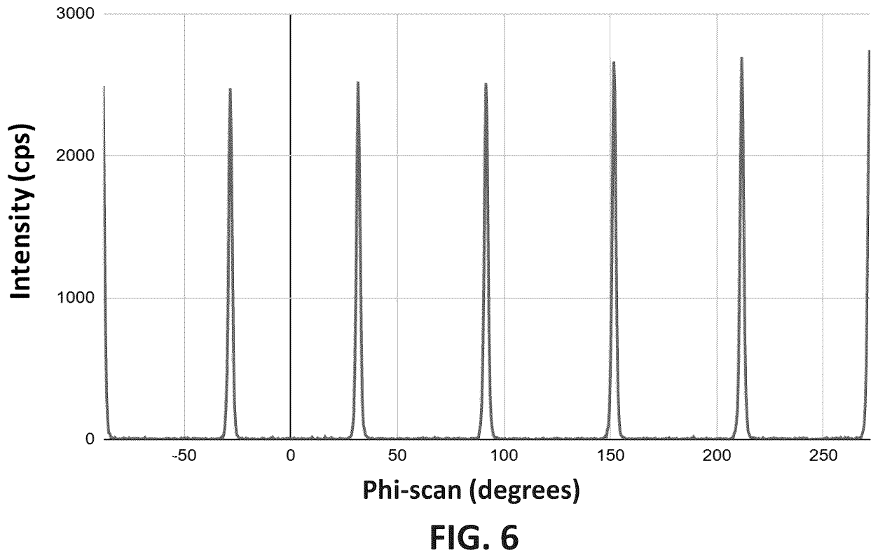

FIG. 6 provides a plot showing results of an X-ray diffraction in-plane phi scan of the material according to the present technology taken along the [10-10] zone axis (Bragg angle fixed at d-spacing for (30-30) plane). The results correspond to the a-axis plane of LiNbO₃. The peak repeats every 60 degrees. These results in FIG. 6 agree with those of FIGS. 4A and 4B with respect to the finding of six-fold symmetry within the plane. This in-plane phi scan of (30-30) planes of LiNbO₃ demonstrates expected 6-fold symmetry of single crystal layer 25 with c-axis orientation.

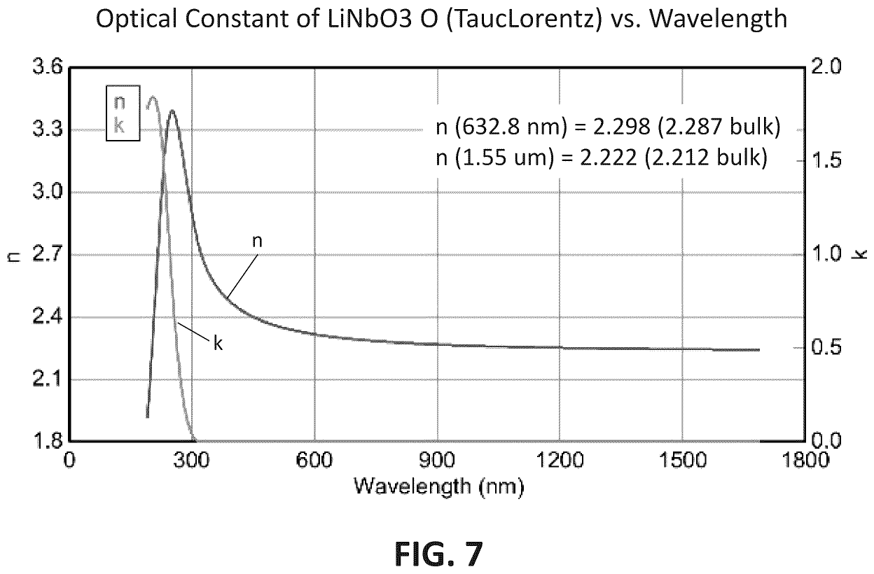

FIG. 7 provides a plot of the real (n) and imaginary (k) parts of the refractive indices of the LiNbO₃ layer 25 versus wavelength (nm) for a material according to the present technology as extracted from spectroscopic ellipsometry for the entire monolithically integrated stack. The extracted refractive indices of the LiNbO₃ show bulk-like values, indicating a high quality, dense film. These results fit a Tauc-Lorentz model for single oscillator.

### Additional Examples, Including Use of Disclosed Materials for Waveguides

Referring again to FIGS. 1A and 1B, pieces of material 1 or material 2 may be produced for purposes of fabricating LiNbO₃ based waveguide devices. In some embodiments, the layer of lithium niobate 25 may be formed on only a portion of the top surface of single crystal oxide buffer layer 20. For example, as shown in FIGS. 1A and 1B, the layer of lithium niobate designated as 25′ has a width that is less than a width (or diameter) of the underlying buffer layer 20 and silicon substrate 15 (and layer 35 in the case of material 5). For waveguide applications of the material(s) 1 and 5 according to the present technology, a thickness and/or width of the layer of lithium niobate 25′, along with the thickness, and composition of the single crystal oxide buffer layer 20, may be varied, and likewise determined and optimized, to suit the requirements and specifications of a particular application. For instance, the single crystal oxide buffer layer 20 may be made sufficiently thick to enable light energy that may not be fully contained within the layer of lithium niobate 25′ during operation of the waveguide to be mainly absorbed in buffer layer 20 to minimize light impinging into the underlying layer(s) 15 and/or 30. Varying compositions of layer 20 formed 110 according to the present technology may provide varying bandgaps and so a variety of single crystal oxide buffer layers 20 may have respective minimum thicknesses required to prevent light from entering layer(s) underlying layer 20. Beyond that constraint for use in waveguides, buffer layer 20 may be formed 110 at any greater thickness above that minimum thickness.

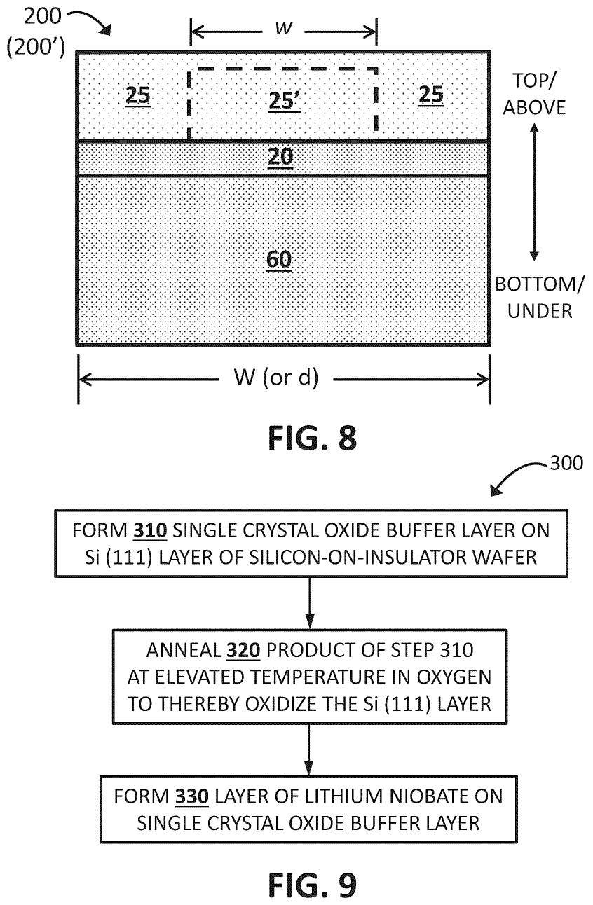

FIG. 8 depicts a cross-sectional view of a material 200, according to some embodiments of the present technology. Material 200 is a variation of material 5 as discussed above with reference to FIG. 1B. In material 300, the single crystal oxide buffer layer 20 may be situated on a silica (SiO₂) layer 60. Material 300 may include the layer of lithium niobate 25 formed on layer 20. A composition, thickness, and physical or other properties of layer 20 and layer 25 may be, or may include, any of those of single crystal oxide buffer layer 20 and layer of lithium niobate 25 as described above with reference to FIGS. 1A and 1B. In an example (not shown in FIG. 8), a 001-oriented Si carrier wafer may be situated underneath silica layer 60.

FIG. 9 depicts a flowchart of a method 300 for manufacturing material 200, according to some embodiments of the present technology. Method 300 is a variation of method 100, as shown and described above with reference to FIG. 2. Method 300 includes the step of forming 310, or otherwise depositing, single crystal oxide buffer layer 20 on an Si (111) layer of an SOI wafer. In an example, layer 20 may be formed 310 on the aforementioned Si (111) layer using MBE. In one embodiment, the forming 310 of method 300 may proceed according any of the variants of step 210 of method 100 suitable for use with Si (111) as silicon substrate 15, as discussed above with reference to FIG. 2. In some embodiments, the Si (111) layer of the SOI wafer may be the topmost layer thereof.

After the single crystal oxide buffer layer 20 is formed 310 on the aforementioned Si (111) layer in method 300, the resultant product is annealed 320 at an elevated temperature in the presence of oxygen (O₂) to thereby oxidize the Si (111) layer. In an example, the annealing 320 step of method 300 is performed under process conditions (including temperature) sufficient to fully oxidize the aforementioned Si (111). A process condition for the annealing 320 of method 100 may include an annealing temperature that is sufficiently high enough to oxidize the Si (111) layer in a practical amount of time, but not too so high that there is evaporation of the single crystal oxide buffer layer 20. In some embodiments, the annealing 320 temperature may be from about 875° C. to about 950° C. The annealing 320 temperature may be selected based at least upon a composition of the single crystal oxide buffer layer 20. In an example, the annealing 320 temperature may be about 900° C.

The result of step 320 in method 300 is that, with the elimination of Si (111) after the annealing 320 step, the single crystal oxide buffer layer 20 is situated on silica layer 60, as shown in FIG. 8. The anealling 320 step thereby eliminates the silicon substrate 15 such that silica layer 60 replaces it as the substrate for the single crystal oxide buffer layer 20. Method 300 may then proceed to a forming 330 step in which the layer of lithium niobate 25 is formed, or otherwise deposited on single crystal oxide buffer layer 20. In an example, layer 25 may be formed 330 on the single crystal oxide buffer layer 20 using RF sputtering. In one embodiment, the forming 330 step of method 300 may proceed according to any of the variants of step 115 of method 100 suitable for use with Si (111) as silicon substrate 15, as discussed above with reference to FIG. 2.

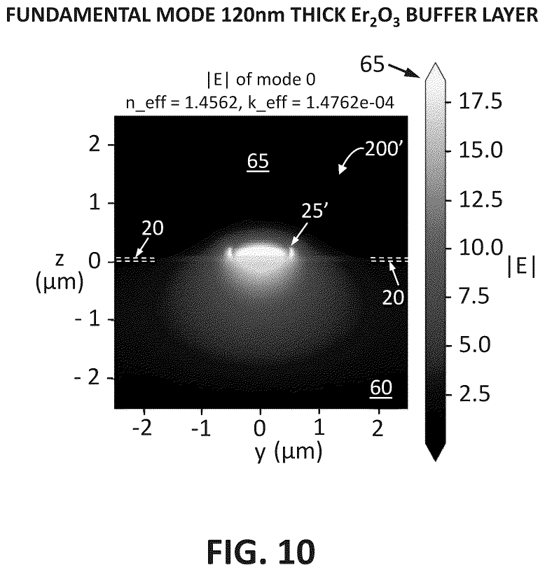

Material 200 and method 300 may be adapted for purposes of fabricating LiNbO₃ based waveguide devices (e.g., waveguide device 200′, as shown in FIGS. 8 and 10). Referring to FIG. 8, in some embodiments, the layer of lithium niobate 25 may be formed on only a portion of the top surface of single crystal oxide buffer layer 20. For example, as shown in FIG. 8, the layer of lithium niobate designated as 25′ has a width (w) that is less than a width (W) (or diameter, d) of the underlying single crystal oxide buffer 20 and silica 60 layers. In an example, silica layer 60 of material 200 (and also waveguide 200′) may be about 5 μm thick. In another example, silica layer 60 of material 200 (and also waveguide 200′) may be about 3 μm thick.

For waveguide applications of material 200 according to the present technology, a thickness and/or a width of the layer of lithium niobate 25′, along with the thickness, and composition, of the single crystal oxide buffer layer 20, may be varied, and likewise determined and optimized, to suit the requirements and specifications of a particular application of waveguide 200′. For instance, the thickness of the single crystal oxide buffer layer 20 may be made sufficiently thick to enable light energy that may not be fully contained within the layer of lithium niobate 25′ during operation of waveguide 200′ to be mainly absorbed in buffer layer 20 to minimize light impinging into the underlying silica 60.

Varying compositions of layer 20 formed 110 according to the present technology may provide varying bandgaps and so a variety of single crystal oxide buffer layers 20 may have respective minimum thicknesses required to prevent light from entering layer(s) underlying silica layer 60. Beyond that constraint for use in waveguide 200′, buffer layer 20 may be formed 310 at any greater thickness above that minimum thickness. In an example, a minimum thickness of single crystal oxide buffer layer 20 in waveguide device 200′ is 80 nm. Referring back to the above discussion of material 1 and material 5 with reference to FIG. 1A and FIG. 1B, respectively, it may be expected that, for waveguide applications of either of those materials having Si substrate 15 underlying single crystal oxide buffer layer 20, layer 20 may need to be considerably thicker (e.g., micron(s) thick). Similarly, it may be the case that a buffer layer 20 minimum thickness requirement for waveguide applications of material 200 may vary inversely with a thickness of silica layer 60.

FIG. 10 depicts a heat map style cross-sectional view of waveguide device 200′ of FIG. 8 under a simulated energization test. The single crystal oxide buffer layer 20 of waveguide device 200′ in the example of FIG. 10 is composed of Er₂O₃. A thickness of the layer of lithium niobate 25 is 120 nm (about 1000 angstrom), which, unlike buffer layer 20 thickness, was held constant in the simulation. Silica layer 60 has a thickness of 5 μm and the width (w) of the layer of lithium niobate 25 is 1 μm, both of which were also held constant in the simulation. Buffer layer 20 and silica layer 60 are labeled in FIG. 10 in correspondence with those features illustrated in FIG. 8. The region above layers 20 and 25 is air 60.

In FIG. 10, the z- and y-axes are in microns and graphic 65 provide the key to the amplitude of the electric field (|E|, 10⁻⁴ V/m) shading/coloration of the heat map depicting light energy withing the layer of lithium niobate 25′, single crystal oxide buffer layer 20 and air 65. As expected, light is mainly concentrated in layer 25′ with very little leakage into air 65. Dissipation of the light drops off sharply in the silica layer 65, with little entering therein after z=−1 μm and none being detected after about z=−2 μm (z=0 is the boundary between layers 20 and 60 in waveguide 200′). Less light dissipating into silica layer 60 would be expected with a thicker buffer layer 20. The simulation shown in FIG. 10 shows that, with the aforementioned dimensions of the waveguide 200′ layers at the stated dimensions, an acceptable confinement of the fundamental mode (e.g., confinement factor) for waveguide device 200′ may be achieved according to the simulated example.

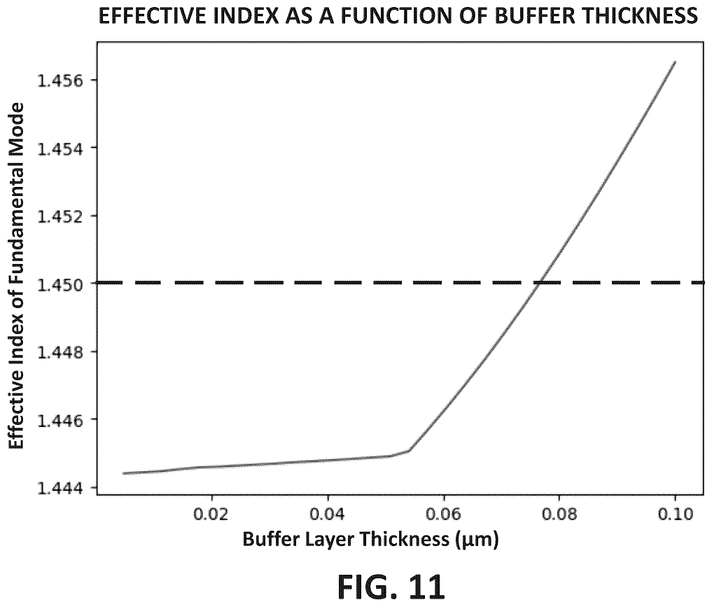

FIG. 11 depicts a plot of effective index of fundamental mode (y-axis) versus thickness (nm) of the Er₂O₃ single crystal oxide buffer layer 20 from the simulation example of FIG. 10. The horizontal dashed line, y=1.450, is the refractive index of silica layer 60. As shown on the x-axis in FIG. 10, the thickness of single crystal oxide buffer layer 20 of waveguide 200′ was swept from 5 nm to 100 nm. The solid line in FIG. 10 demonstrates that, as layer 20 thickness increases, the effective index of the entire waveguide device 200′ structure increases. At and above 0.08 μm (80 micron) thickness for single crystal oxide buffer layer 20 of Er₂O₃, the effective index meets and exceeds 1.450, thus providing the minimum thickness of layer 20 for use of waveguide 200′ of the design tested as shown in FIG. 10.

### CONCLUSION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “on,” “connected,” or “coupled” means having any attachment, connection or coupling, either direct or indirect, between two or more elements; the attachment, coupling, or connection between the elements can be physical, logical, or a combination thereof. Similarly, the phrase “directly on” means a direct attachment, connection, or coupling without any intermediate elements, layers, etc. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, various aspects may be presented in other system claims, composition of matter claims, method claims, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A material comprising:
a silicon substrate;
a single crystal oxide buffer layer formed on the silicon substrate; and
a layer of lithium niobate formed on the single crystal oxide buffer layer.

2. The material of claim 1, wherein the silicon substrate comprises one of:
a silicon wafer; or
a device silicon layer of a silicon on insulator (SOI) wafer.

3. The material of claim 1, wherein the single crystal oxide buffer layer comprises one of:
a spinel buffer;
bixbyite buffer;
wurtzite buffer;
zinc oxide; or epitaxial oxide.

4. The material of claim 3, wherein the single crystal oxide buffer layer comprises the bixbyite buffer and the bixbyite buffer comprises a composition defined as R1ₓR2₁₋ₓO₃, wherein R1 or R2 can be any Group 3 element that normally forms in a bixbyite crystal structure.

5. The material of claim 1, wherein the single crystal oxide buffer layer comprises at least one of: aluminum oxide (Al₂O₃); gadolinium oxide (Gd₂O₃), neodymium oxide (Nd₂O₃), yttrium oxide (Y₂O₃), praseodymium oxide (Pr₂O₃), erbium oxide (Er₂O₃), and indium oxide (In₂O₃).

6. The material of claim 1, wherein the layer of lithium niobate is:
epitaxially grown on the silicon substrate via the single crystal oxide buffer layer; and
comprises a thickness of in a range of 1 nanometer (nm) to about 1 micron (μm).

7. The material of claim 1, wherein the layer of lithium niobate has a thickness of greater than or equal to 8 unit cells.

8. The material of claim 1, wherein the layer of lithium niobate is at least one of ferroelectric and piezoelectric.

9. A waveguide device comprising:
a silica layer;
a single crystal oxide buffer layer formed on the silica layer, wherein:
the single crystal oxide buffer layer comprises a top surface and a bottom surface; and
the bottom surface of the single crystal oxide buffer layer contacts the silica layer; and
a layer of lithium niobate is formed on a portion of the top surface of the single crystal oxide buffer layer.

10. The waveguide device of claim 9, wherein the single crystal oxide buffer layer comprises:
a bixbyite buffer; and
a thickness of from about 1 nanometer (nm) to about 1 micron (μm).

11. The waveguide device of claim 10, wherein the bixbyite buffer comprises a composition defined as R1×R21−xO3, wherein R1 or R2 can be any Group 3 element that normally forms in a bixbyite crystal structure.

12. The waveguide device of claim 9, wherein the single crystal oxide buffer layer comprises:
an epitaxial oxide; and
a thickness of from about 1 nanometer (nm) to about 1 micron (μm).

13. The waveguide device of claim 9, wherein the lithium niobate layer:
is epitaxially grown on the silica layer via the single crystal oxide buffer layer; and
comprises a thickness of greater than or equal to 8 unit cells.

14. The waveguide device of claim 9, wherein the silica layer comprises one of:
a silicon wafer; or
a device silicon layer of a silicon on insulator (SOI) wafer.

15. A method of producing a material, the method comprising:
forming a single crystal oxide buffer layer on a silicon substrate; and
forming a layer of lithium niobate on the single crystal oxide buffer layer.

16. The method of claim 15, wherein forming the layer of lithium niobate comprises epitaxially growing the layer of lithium niobate on the silicon substrate via the single crystal oxide buffer layer, wherein the layer of lithium niobate comprises a thickness in a range of 10 to 120 nanometers.

17. The method of claim 15, wherein forming the single crystal oxide buffer layer on the silicon substrate comprises forming the single crystal oxide buffer layer having a thickness in a range from about 1 nm to about 10 μm on the silicon substrate.

18. The method of claim 15, wherein forming the layer of lithium niobate on the single crystal oxide buffer layer comprises:
using radio frequency (RF) sputtering to form the layer of lithium niobate on the single crystal oxide buffer layer at a predetermined thickness from a lithium-rich sputtering target.

19. The method of claim 15, wherein forming the layer of lithium niobate comprises:
initially depositing a seed layer of lithium niobate on the single crystal oxide buffer layer; and
depositing a remainder of the layer of lithium niobate to a predetermined thickness using metal-organic chemical vapor deposition (MOCVD).

20. The method of claim 15, wherein:
the silicon substrate comprises Si;
forming the single crystal oxide buffer layer comprises forming the single crystal oxide buffer layer on the Si; and
the method further comprises:
annealing, at an elevated temperature and in the presence of oxygen, a product of forming the single crystal oxide buffer layer on the Si.
